(19) United States
(12) Patent Application Publication
(10) Pub. No.: US 2001/0047219 A1
(43) Pub. Date: Nov. 29, 2001

(54) Method of machining a multi-layer workpiece

(76) Inventor: Erik Oden, Taby (SE)

Correspondence Address: Todd T. Taylor, TAYLOR & AUST, P.C., 142 S. Main St., P.O. Box 560, Avilla, IN, 46710, US

(21) Appl. No.: 09/774,313

(22) Filed: Jan. 31, 2001

Related U.S. Application Data
(60) Provisional application No. 60/179,451, filed on Feb. 1, 2000.

(51) Int. Cl. G06F 19/00

(52) U.S. Cl. 700/159; 700/160

(57) ABSTRACT

A method of machining a multi-layer workpiece includes the steps of: rotating a cutting tool at an operating speed; contacting the cutting tool against the workpiece; moving the cutting tool through one layer and into another layer within the workpiece; and detecting at least one vibration characteristic associated with the cutting tool during the contacting step and/or moving step.

### BACKGROUND OF THE INVENTION

1. Field of the Invention.

The present invention relates to a method of machining, and, more particularly, to a method of machining a multi-layer workpiece

2. Description of the Related Art

When machining a workpiece in the form of a material sheet, it is important to know the position of the workpiece surface relative to a cutting tool used to machine the workpiece. The workpiece may be in the form of a multi-layer workpiece including multiple layers of material such as aluminum, titanium, stainless steel and fiber-reinforced composite materials. Multi-layer workpieces may be particularly useful in the aerospace industry since they provide high strength, light weight structures. In addition to determining the surface position of the workpiece, it is also important to know the location of the interfaces between the different layers of the multi-layer workpiece. Since the cutting tool may cut differently within the different materials, it is important to know the boundary layers of the different layers as the cutting tool progresses through the workpiece.

For many applications, an opening which is machined into the workpiece receives a fastener for fastening the workpiece to a structural member, another workpiece, etc. To ensure that a proper length fastener is utilized, it is necessary to determine the thickness of the workpiece.

It is known to use various types of detectors for detecting the exterior surface of a workpiece to be machined. For example, edge finders utilize a measuring probe with a ball at the tip of the probe. The ball makes contact with the exterior surface of the workpiece and a microswitch is made to provide an output signal to a controller. Conductivity probes are similar to edge finders, except that the sensing element measures the conductivity of the workpiece. It is also known to utilize lasers which reflect a light beam from the surface of the workpiece. Lasers tend to be very costly, and are subject to dirt, etc. which scatters the light beam projected upon the workpiece surface.

### SUMMARY OF THE INVENTION

The present invention provides a method of machining a multi-layer workpiece, in which the vibration amplitude and vibration frequency of the cutting tool are utilized to determine contact between the cutting tool and the workpiece, as well as the interface location between adjacent layers in the workpiece.

The invention comprises, in one form thereof, a method of machining a multi-layer workpiece including the steps of: rotating a cutting tool at an operating speed; contacting the cutting tool against the workpiece; moving the cutting tool through one layer and into another layer within the workpiece; and detecting at least one vibration characteristic associated with the cutting tool during the contacting step and/or moving step.

An advantage of the present invention is that contact between the cutting tool and the workpiece is accurately detected.

Another advantage is that the interface between adjacent layers is also accurately detected.

Yet another advantage is that existing machines may be easily retrofitted by simply adding one or more accelerometers at selected locations without modifying the existing structure of the machine.

A further advantage is that the wear state of the cutting tool may be accommodated in the calculation techniques utilized for detection of contact with the workpiece or the interface between adjacent layers.

A still further advantage is that the thickness of the workpiece may be determined utilizing the machining method of the present invention.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a sectional view of an embodiment of a machine utilized for carrying out a method of machining of the present invention;

FIG. 2 is a graphical illustration of the vibration amplitude of the cutting tool as it contacts and passes through the layers of the multi-layer workpiece; and

FIG. 3 is a graphical illustration of the vibration frequency of the cutting tool within a composite layer and an aluminum layer.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

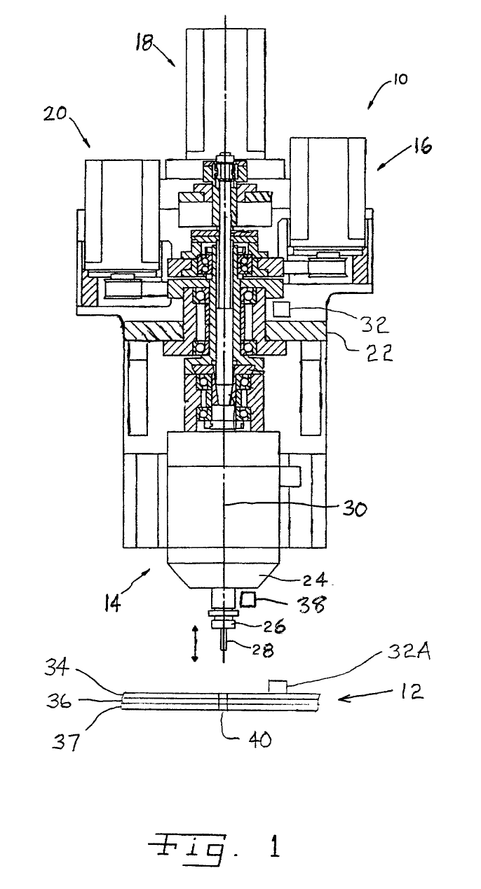

Referring now to the drawings, and more particularly to FIG. 1, there is shown a machine 10 used for machining a multi-layer workpiece 12 in accordance with a method of machining of the present invention. Machine 10 generally includes a spindle motor 14, radial offset mechanism 16, axial feed mechanism 18 and eccentric rotation mechanism 20, each carried by a frame 22. Machine 10 may be stationarily mounted or may be mounted in a mobile fashion such as to a robot arm.

Spindle motor 14 includes a body 24 and a rotatable tool holder 26 configured for holding a cutting tool 28 during rotation. Cutting tool 28, which defines a tool axis 30, can be designed for producing a hole (not shown) in workpiece 12. Cutting tool 28, such as a drill bit, milling tool, etc. is moved toward and into workpiece 12 so as to form a hole in workpiece 12 which is the same diameter as cutting tool 28 (such as in a simple drilling operation) or larger than the diameter of cutting tool 28. For further details of the general operation of machine 10, reference is hereby made to U.S. Pat. No. 5,971,678 (Linderholm), which is assigned to the assignee of the present invention. For details concerning the use of such a machine to form a hole which is larger than the diameter of the cutting tool, reference is hereby made to U. S. Pat. No. 5,641,252 (Eriksson et al.), which is also assigned to the assignee of the present invention.

Accelerometer 32 is mounted to frame 22 of machine 10 at a location which is sufficient to receive vibrational energy transmitted from cutting tool 28. Accelerometer 32 provides an output signal to a controller (not shown) used to detect the position of cutting tool 28 relative to workpiece 12, as will be described in more detail hereinafter. Alternatively, accelerometer 32 may be placed directly upon workpiece 12 for receiving vibrational energy transmitted therefrom such as indicated by accelerometer 32A.

Workpiece 12 includes a plurality of layers, with each layer being in the form of a laminae having a metallic or composite structure. In the embodiment shown, workpiece 12 includes three laminae 34, 36 and 37 with laminae 34 having a composite structure, laminae 36 having a metallic structure, and laminae 37 having a composite structure. More particularly, in the embodiment shown, lamina 34 and 37 have a fiberglass structure and laminae 36 has an aluminum structure.

A digital encoder 38 is positioned relative to tool holder 26 to sense the rotational speed of tool holder 26 and cutting tool 28. Encoder 38 provides an output signal to the controller for use in the machining method of the present invention, as will be described in more detail hereinafter. Alternatively, a tachometer rather than a digital encoder may be positioned relative to tool holder 26 for sensing the rotational speed thereof.

According to an embodiment of a method of the present invention, machine 10 is used for forming a hole 40 in multi-layer workpiece 12. More particularly, cutting tool 28 is rotated at an operating speed. When rotating, cutting tool 28 transmits vibrations to accelerometer 32, which in turn provides an output signal corresponding to at least one vibration characteristic associated with cutting tool 28. The vibration characteristic is in the form of an amplitude and/or a frequency, as will be described in more detail hereinafter. As cutting tool 28 is contacted with and moved through multi-layer workpiece 12, the vibration amplitude and/or vibration frequency change. The changes in the vibration characteristics may be used to determine when cutting tool 28 contacts upper laminae 34, when cutting tool 28 moves through laminae 34 and contacts laminae 36, when cutting tool 28 moves through laminae 36 and contacts laminae 37, and when cutting tool 28 exits from the bottom of workpiece 12. Referring to Table 1 below and FIG. 2, conjunctively, the vibration amplitude of cutting tool 28 as it passes through workpiece 12 will be described in more detail.

TABLE 1

| No. | Time (s) | Event | Characteristics |
|---|---|---|---|
| 1 | 0-2 | Tool in air | Low amplitude. Vibrations comes from the machine |
| 2 | 3 | Contact | Amplitude rises gently when impact occurs |
| 3 | 3-11.5 | Composite | Amplitude remains on the same level |
| 4 | 11.5 | Transition/Aluminum | A transient marks the impact with aluminum |
| 5 | 11.5-26.5 | Aluminum | Amplitude slightly higher than composite. Random |
| | | | transients |
| 6 | 26.5 | Transition/Composite | Amplitude goes down. No distinct variation in |
| | | | amplitude |
| 7 | 26.5-35 | Composite | Amplitude levels out. No transients |
| 8 | 35 | Breakthrough | Tool breaks through composite with a small transient. |
| 9 | 35-37 | Overdrill | Tool is scraping the edge of the hole, causing some |
| | | | transients |
| 10 | 37-41.3 | Return | Tool goes back. Amplitude is decreasing to air (1) level. |

When cutting tool 28 is brought up to operating speed, a certain amount of low amplitude vibrations occur simply as a result of imbalances etc. of the rotating parts within machine 10. The time interval 1 between 0-3 seconds shown in FIG. 2 thus has a low vibration amplitude. At time interval 2, cutting tool 28 contacts upper laminae 34 of workpiece 12 which causes the vibration amplitude to increase. The vibration amplitude does not spike, but rather increases at a relatively slow amplitude rise as cutting tool 28 enters laminae 34. The vibration amplitude remains relatively constant during time interval 3 extending between 3 and 11.5 seconds. As cutting tool 28 passes through laminae 34 and enters aluminum laminae 36, the vibration amplitude rapidly spikes and remains at a higher vibration amplitude level through time interval 5 as cutting tool 28 passes through aluminum laminae 36. At time interval 6 corresponding to proximately 26.5 seconds, cutting tool 28 leaves laminae 36 and enters composite laminae 37. The vibration amplitude decreases a noticeable extent, and transient spikes are reduced. During time interval 7, cutting tool 28 passes through third laminae 37 and the vibration amplitude remains relatively constant with few transient spikes. At time interval 8 corresponding to approximately 35 seconds, cutting tool 28 breaks through third laminae 37 at the bottom of work piece 12, thereby causing a small but noticeable transient spike in the vibration amplitude. By knowing the feed rate of cutting tool 28 through workpiece 12, the time difference between time interval 8 at which cutting tool 28 breaks through laminae 37 and time interval 2 at which cutting tool 28 contacts laminae 34, the thickness of workpiece 12 may be determined. Cutting tool 28 continues to be moved in an axial direction to ensure that cutting tool 28 passes through workpiece 12. Cutting tool 28 scrapes the sidewall edges of hole 40 to some extent, thereby causing some transient vibration amplitude spikes. During time interval 10, extending from approximately 37-41.3 seconds, cutting tool 28 is moved in an opposite axial direction to return to a home position. During the return movement of cutting tool 28, the vibration amplitude again decreases to a level which generally only corresponds to small vibrations caused by machine 10.

From the foregoing, it is apparent that the vibration amplitude of cutting tool 28 may be easily used to detect when cutting tool 28 contacts workpiece 12. By simply setting a threshold value for the vibration amplitude, contact between cutting tool 28 and laminae 34 may be easily detected. Moreover, in a case where cutting tool 28 moves from a composite to an aluminum laminae, such as when cutting tool 28 moves through laminae 34 and into aluminum laminae 36, the vibration amplitude again provides a noticeable spike which may be used to detect the interface between adjacent laminae. However, it may also be noted that when cutting tool 28 moves through aluminum laminae 36 into composite laminae 37, the vibration amplitude does not change a significant extent. Moreover, in the case where adjacent layers are formed from different metallic materials or different composite materials, the vibration amplitude may not change to an appreciable extent. Accordingly, although the vibration amplitude provides a good indicator of contact between tool 28 and laminae 34, it may not provide a good indicator of the interface location between adjacent layers of workpiece 12.

It will also be noted from FIG. 1 that the vibration amplitude rise of cutting tool 28 is much lower when cutting tool 28 enters a composite layer, as compared to when cutting tool 28 enters a metallic layer. More particularly, as cutting tool 28 enters a metallic layer, the vibration amplitude spikes quite rapidly. Thus, it is possible to use various numerical analysis techniques to determine the vibration amplitude rise and thereby infer whether cutting tool 28 is entering a composite or a metallic layer.

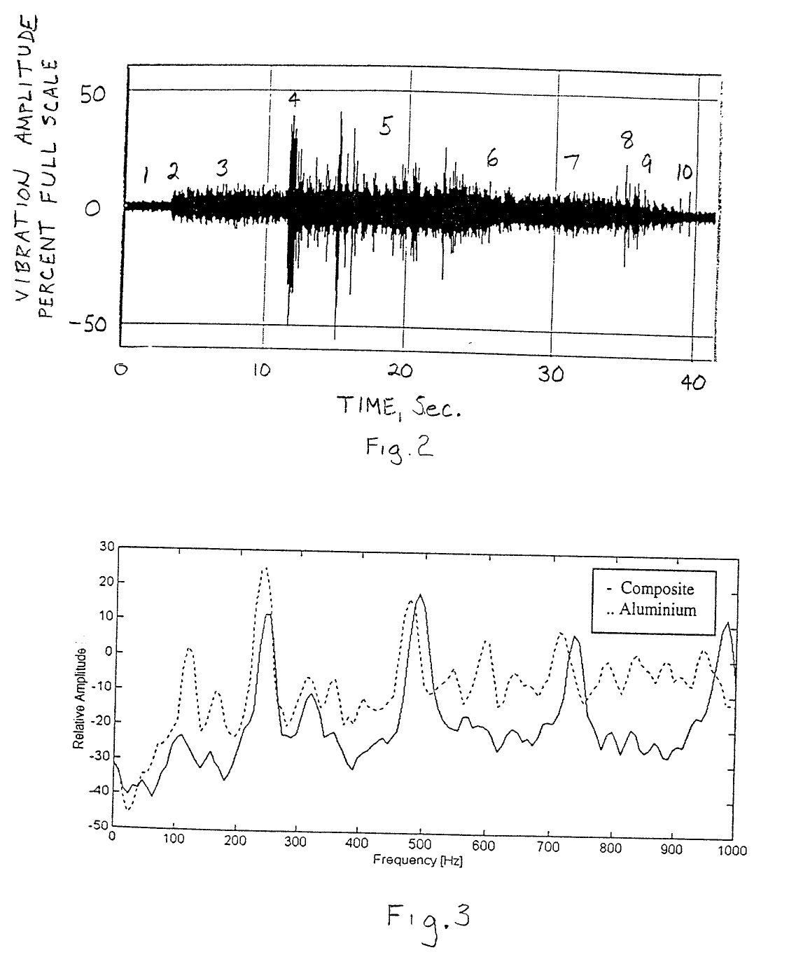

To determine the interface between adjacent layers of multi-layer workpiece 12, it has been found that the vibration frequency rather than the vibration amplitude tends to be more accurate. Referring to FIG. 3, a frequency spectrum for a composite layer and an aluminum layer are illustrated. When cutting tool 28 is cutting an aluminum layer, the peaks drop in frequency. The simple explanation for this is that the spindle speed drops when entering the aluminum layer as a result of the higher cutting forces required to machine the aluminum layer when compared to the composite layer, and the lack of feed back control for the spindle motor. The peaks drop in frequency to even a greater extend for a titanium layer.

Various numerical analysis techniques may be utilized to determine frequency values and frequency changes of cutting tool 28 when cutting multi-layer workpiece 12. For example, a Fast Fourier Transform technique has been found to provide suitable calculation results to determine the interface between adjacent layers within acceptable error limits. Digital filtering techniques may also be utilized to reduce unwanted noise from the output signal provided by accelerometer 32.

The two primary factors which have been found to effect the vibration amplitude are the type of material which cutting tool is cutting as well as the wear state of cutting tool 28. The principal effect of an advanced wear state of cutting tool 28 is that the vibration amplitude is increased. This can be accommodated through tuning of the controller to adjust the amplitude of the signal received from accelerometer 32. In addition, it may be necessary to filter the signal to remove transients caused by the advanced wear state of cutting tool 28.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of machining a multi-layer workpiece, comprising the steps of:
rotating a cutting tool at an operating speed;
contacting said cutting tool against the workpiece;
moving said cutting tool through one layer and into an other layer within the workpiece; and
detecting at least one vibration characteristic associated with said cutting tool during at least one of said contacting step and said moving step.

2. The method of machining of claim 1, wherein said detecting step is carried out during each of said contacting step and said moving step.

3. The method of machining of claim 1, wherein said at least one vibration characteristic comprises an amplitude and a frequency.

4. The method of machining of claim 3, wherein said detecting step is carried out during each of said contacting step and said moving step, said vibration characteristic comprising said amplitude during said contacting step, and said vibration characteristic comprising said frequency during said moving step.

5. The method of machining of claim 4, said vibration frequency corresponding to said operating speed of said cutting tool.

6. The method of machining of claim 5, said one layer being a non-metallic layer and said other layer being a metallic layer, said vibration frequency decreasing during said moving step.

7. The method of machining of claim 3, wherein said vibration amplitude comprises a vibration amplitude rise change.

8. The method of machining of claim 3, including the step of measuring said frequency with one of an encoder and a tachometer associated with said cutting tool.

9. The method of machining of claim 1, said moving step comprising moving said cutting tool through each layer of the multi-layer workpiece, and said detecting step comprising detecting a vibration amplitude associated with said cutting tool as said cutting tool exits the workpiece.

10. The method of machining of claim 9, including the step of determining a thickness of the workpiece using said detected vibration amplitude.

11. The method of machining of claim 1, including the step of determining a thickness of said workpiece using said at least one vibration characteristic.

12. The method of machining of claim 1, said detecting step being carried out using an accelerometer.

13. The method of machining of claim 12, including the steps of mounting said cutting tool to a machine, and mounting said accelerometer to one of said machine and the workpiece.

14. The method of machining of claim 12, said accelerometer providing an output signal, and including the step of filtering said output signal.

15. The method of machining of claim 1, wherein each said layer comprises a laminae, each said laminae having one of a metallic structure and composite structure.

16. The method of machining of claim 1, including the step of moving said cutting tool in both an axial and radial direction.

17. The method of machining of claim 1, wherein said cutting tool comprises one of a drill bit and milling tool.

18. The method of machining of claim 1, including the step of accommodating said at least one vibration characteristic, dependent upon a wear state of said cutting tool.

19. A method of machining a multi-layer workpiece, each said layer of the multi-layer workpiece having one of a metallic structure and composite structure, said method comprising the steps of:
mounting a cutting tool to a machine;
mounting an accelerometer to one of said machine and the workpiece;
rotating said cutting tool at an operating speed;
contacting said cutting tool against the workpiece;
moving said cutting tool through one layer and into an other layer within the workpiece; and
detecting at least one vibration characteristic associated with said cutting tool using said accelerometer during each of said contacting step and said moving step, said vibration characteristic comprising an amplitude during said contacting step, and said vibration characteristic comprising a frequency during said moving step.
